(19) United States
(12) Patent Application Publication
(10) Pub. No.: US 2009/0186180 A1
(43) Pub. Date: Jul. 23, 2009

(54) RECORDING DEVICE FOR ENHANCED CLINICAL WORKFLOW

(75) Inventors: David Phillip Murawski, Cary, IL (US); Jyothi Jayaraman, Hoffman Estates, IL (US); Christopher Scott Puryear, Schaumburg, IL (US); Mohan Naidu, Bartlett, IL (US); Jode Randall Allen, Stansbury Park, UT (US); Maureen Kay Clancy, Sandy, UT (US); Richard Dirk Jager, Sandy, UT (US); James Jay, Volo, IL (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/017,094

(22) Filed: Jan. 21, 2008

(51) Int. Cl. B32B 33/00

(52) U.S. Cl. 428/40.1

(57) ABSTRACT

A recording device is presented. The recording device includes a material having a front surface and a back surface, wherein the front surface is configured to allow a user to record information, where the back surface has an adhesive disposed thereon, and where the recording device is configured to be removably and re-adherably affixed to the user.

### BACKGROUND

This disclosure relates generally to clinical workflow, and more particularly to a design of a recording device configured to aid in enhancing clinical workflow.

In a caregiving facility, such as a hospital, a patient may be operatively coupled to one or more monitoring devices, where the monitoring devices are configured to monitor vital parameters associated with the patient. The monitoring devices may include a pulse oximeter, an electrocardiogram monitor, a blood pressure monitor, for example, where each monitoring device is configured to monitor one or more vital parameters associated with the patient.

Furthermore, in a caregiving facility, caregivers frequently jot down notes and/or patient information, such as vital parameters associated with the patients, on their hands and/or forearms for the sake of convenience if a patient file is not readily accessible. These notes and/or patient information may subsequently be transcribed and/or transferred to a file or a clinical information system. Unfortunately, in certain situations, the notes recorded on the hands and/or forearms of the clinicians may become illegible by the time the clinician tries to record the notes. In addition, at the end of a shift, the clinicians may have to expend their effort in scrubbing off these notes from their hands and/or forearms.

Presently available techniques entail use of a note pad to jot down any notes and/or patient information. However, in certain situations, it may not be convenient to record information on the note pad. Also, the clinician may forget to carry a note pad at all times.

It may therefore be desirable to develop a design of a recording device that may be configured to advantageously aid the clinician in easily recording information, thereby enhancing the clinical workflow. More particularly, it may be desirable to enhance ease of recording patient information, while minimizing discomfort to the clinician.

### BRIEF DESCRIPTION

In accordance with aspects of the present technique, a recording device is presented. The recording device includes a material having a front surface and a back surface, where the front surface is configured to allow a user to record information, where the back surface has an adhesive disposed thereon, and where the recording device is configured to be removably and re-adherably affixed to the user.

In accordance with further aspects of the present technique, a pad of recording devices is presented. The pad includes a stack of a plurality of recording devices, where each of the plurality of recording devices is removably adhered to at least one recording device, where each of the plurality of recording devices includes a material having a front surface and a back surface, where the front surface is configured to allow a user to record information, where the back surface has an adhesive disposed thereon, and where the recording device is configured to be removably and re-adherably affixed to the user.

In accordance with further aspects of the present technique, a method for recording information via use of a recording device, where the recording device includes a material having a front surface and a back surface, where the front surface is configured to allow a user to record information, where the back surface has an adhesive disposed on the back surface, and where the recording device is configured to be removably and re-adherably affixed to the user, is presented. The method includes disposing the recording device on the user. Further, the method includes recording information on the recording device. Additionally, the method includes transferring the recorded information to a storage device.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an information recording system via use of an exemplary recording device, in accordance with aspects of the present technique;

FIG. 2 is a front view of an embodiment of a first surface of the exemplary recording device of FIG. 1, in accordance with aspects of the present technique;

FIG. 3 is a front view of an embodiment of a second surface of the exemplary recording device of FIG. 1, in accordance with aspects of the present technique;

FIG. 4 is a front view of another embodiment of the exemplary recording device of FIG. 1, in accordance with aspects of the present technique;

FIG. 5 is a diagrammatic illustration of the exemplary recording device disposed on an upper-body garment of a user, in accordance with aspects of the present technique;

FIG. 6 is a diagrammatic illustration of the exemplary recording device disposed on a lower-body garment of a user, in accordance with aspects of the present technique;

FIG. 7 is a diagrammatic illustration of the exemplary recording device disposed on the body of a user, in accordance with aspects of the present technique;

FIG. 8 is a diagrammatic illustration of the exemplary pad of recording devices, in accordance with aspects of the present technique; and

FIG. 9 is a flow chart illustrating an exemplary method for recording information using the exemplary recording device of FIG. 1, in accordance with aspects of the present technique.

### DETAILED DESCRIPTION

Although the exemplary embodiments illustrated hereinafter are described in the context of a healthcare application, it will be appreciated that use of the recording device in industrial applications are also contemplated in conjunction with the present technique. More particularly, the recording device may find application in areas that entail monitoring of equipment, maintenance and/or servicing of machinery, inventory control, or the like.

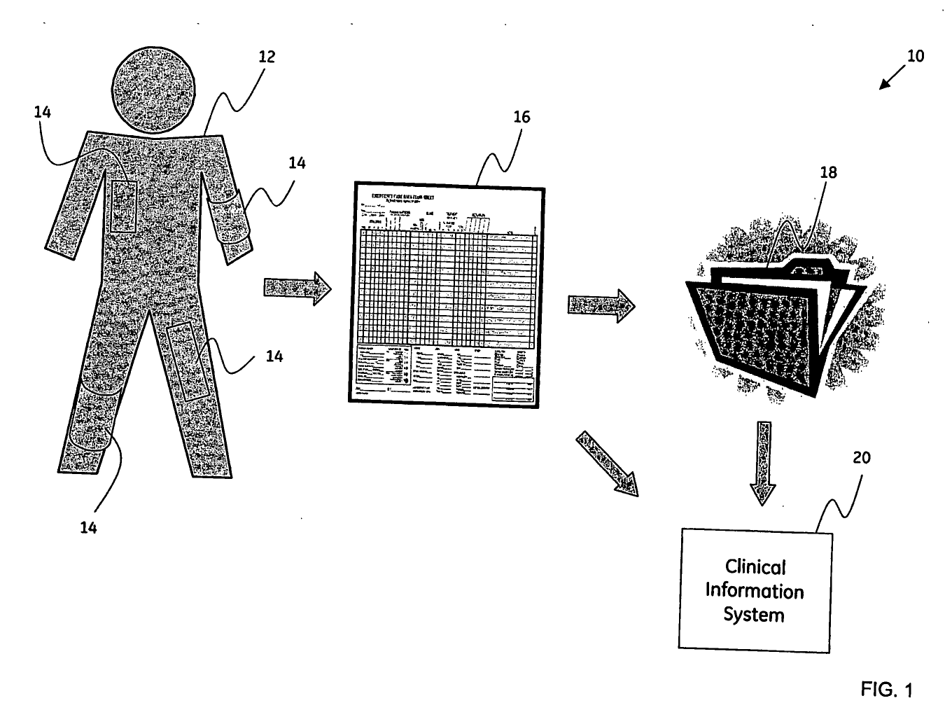

FIG. 1 is a block diagram of an exemplary patient monitoring system 10, in accordance with aspects of the present technique. More particularly, the system 10 may be configured to aid a clinician 12 in recording information associated with a patient (not shown). In one embodiment, the information may include notes corresponding to the patient. The information may also include vital signs associated with the patient, such as a temperature, a blood pressure, a heart rate, muscle activity, brain activity, or the like.

As previously noted, users, such as clinicians, frequently jot down notes and/or patient information on their hands and/or forearms, where the notes and/or patient information may subsequently be transcribed and/or transferred to a patient file or a clinical information system. Unfortunately, the notes recorded on the hands and/or forearms of the clinicians may become illegible by the time the clinician tries to record the notes, or the clinicians may have to expend their effort in scrubbing off these notes from their hands and/or forearms at the end of a shift, thereby resulting in diminished clinical workflow. In accordance with exemplary aspects of the present technique means for enhancing clinical workflow is presented. More particularly, a recording device 14 configured to aid the clinician in enhancing clinical workflow is presented.

The recording device 14 may be configured to aid the clinician 12 in recording patient information, where the patient information may include notes corresponding to the patient and/or patient parameters such as a heart rate, a blood pressure, a blood oxygen level, or a temperature. In accordance with aspects of the present technique, the recording device 14 may be disposed on the body of the clinician 12, such as on the forearms or hands, in certain embodiments. The recording device 14 may be removably disposed on the body of the clinician 12. Alternatively, the recording device 14 may also be removably and re-adherably disposed on a clothing of the clinician 12. The clinician 12 may record information by writing on the recording device 14. In one embodiment, the clinician 12 may use a waterproof marker to record the information on the recording device 14.

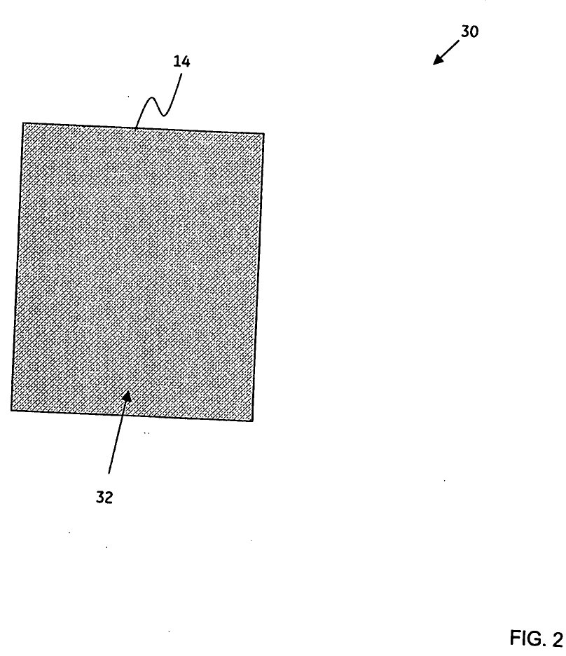

Further, in certain embodiments, the recording device 14 may include a paper, a flexible plastic, a cloth, a ribbon, or other tear resistant materials. It may be noted that the recording device 14 may include a first surface and a second surface. FIG. 2 illustrates a front view 30 of one embodiment of the recording device 14 (see FIG. 1). Reference numeral 32 may be representative of a first surface of the recording device 14. The first surface may include a front surface, in one embodiment. Also, in accordance with aspects of the present technique, the front surface 32 of the recording device 14 may include a writable surface. In other words, the user, such as the clinician 12 (see FIG. 1), may use the front surface 32 to record information.

Moreover, in certain situations, the clinician 12 may be disposed at a location remote from a storage device. As used herein, the term storage device may be used to refer to a clinical flow sheet, a patient chart, a patient file, or a clinical information system. It may be desirable for the clinician 12 to temporarily note down patient information and subsequently transfer the information to a desirable storage device. Accordingly, the front surface 32 of the recording device 14 may be configured as a writable surface to allow the clinician 12 to record information. In certain embodiments, the clinician 12 may record information on the front surface 32 of the recording device 14 via use of a marking device, such as a pen, a pencil, or a marker. The marking device may also include an erasable marking device. Also, in one embodiment, the recording device 14, and more particularly, the front surface 32 of the recording device 14 may be configured to include a waterproof surface. By implementing the front surface 32 of the recording device 14 to include a waterproof surface, any accidental erasure of the recorded information may advantageously be prevented.

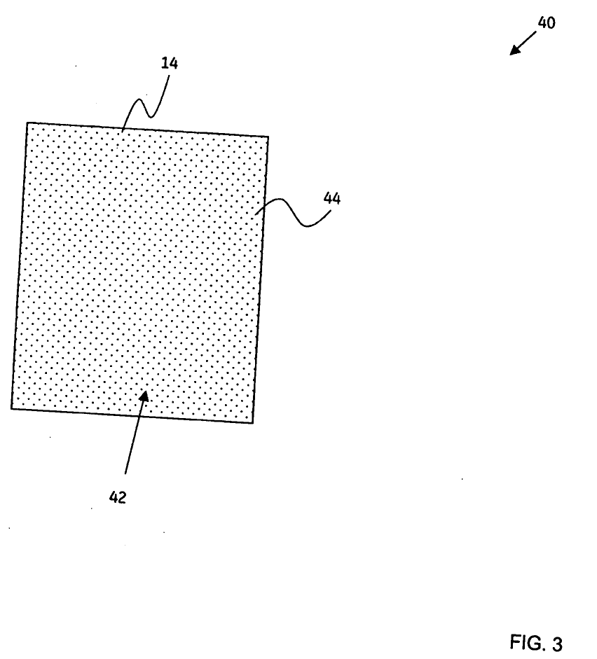

Turning now to FIG. 3, a front view 40 of one embodiment of the recording device 14 (see FIG. 1) is illustrated. Reference numeral 42 may be representative of a second surface of the recording device 14. In one embodiment, the second surface may include a back surface. In accordance with aspects of the present technique, the back surface 42 of the recording device 14 may include an adhesive 44 disposed thereon. In the example illustrated in FIG. 3, the adhesive 44 is shown as being disposed on the entire back surface 42 of the recording device 14. However, as will be appreciated, the adhesive 44 may be disposed on a portion of the back surface 42 of the recording device 14. In one embodiment, the adhesive may be disposed on at least a portion of the back surface 42. The adhesive 44 may be configured to aid the recording device 14 in being removably and/or re-adherably affixed to the clinician 12. In accordance with aspects of the present technique, the recording device 14 may be disposed on the body of the clinician 12, clothing of the clinician 12, or a combination thereof.

Additionally, in one embodiment, the adhesive 44 may include a colorless adhesive. Moreover, the adhesive 44 may also include a clear and non-marking adhesive. Furthermore, the adhesive 44 may include a re-stickable adhesive. Accordingly, the adhesive 44 may be configured to aid in easily affixing the recording device 14 to the clinician 12 and/or removing the recording device 14 without leaving marks or residue on the clinician 12. Moreover, the adhesive 44 may also be configured to aid in re-adhering the recording device 14 to the clinician. In other words, the recording device 14 may be re-used multiple times.

With returning reference to FIG. 1, once the clinician 12 has recorded desired information on the front surface 32 (see FIG. 2) of the recording device 14, it may be desirable to transfer the information to a desired storage device. In the example illustrated, the storage device is shown as including a clinical flow sheet template 16. The clinician 12 may peel off the recording device 14 from his/her body or clothing and transfer the recorded information on a clinical flow sheet template 16 corresponding to a patient, in one embodiment. The clinical flow sheet template 16 may then be disposed in a respective patient file 18. Further, the patient information may also be recorded in a clinical information system (CIS) 20. Alternatively, the clinician 12 may peel off the recording device 14 and place the recording device 14 on the clinical flow sheet template 16. In certain embodiments, the clinician 12 may scan the peeled off recording device 14 and upload the information directly to the CIS 20. In different embodiments, the clinician 12 may transfer the information recorded on recording device 14 to the desired storage device before, after, or both before and after removing or unpeeling the recording device 14 from his/her body or clothing.

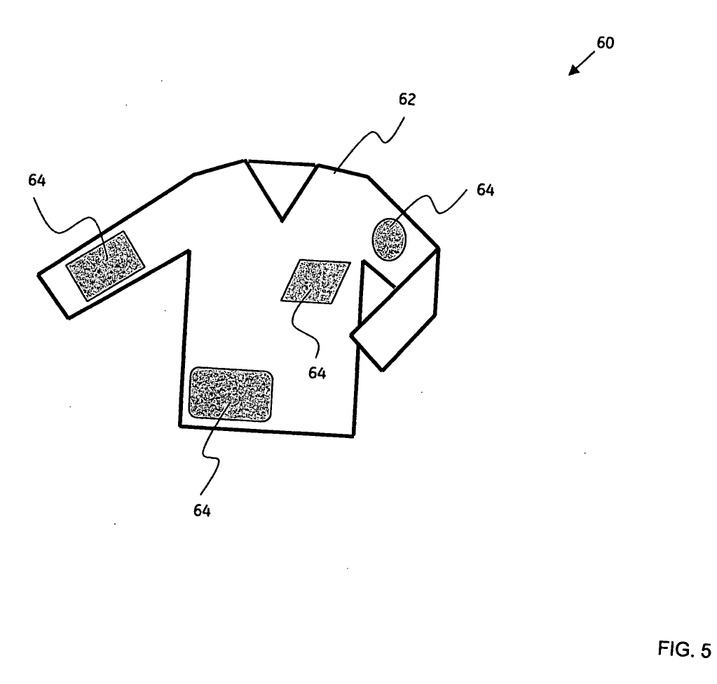

Referring again to the recording device 14, it may be noted that the recording device 14 may be patterned and shaped into a wide variety of shapes. More particularly, the recording device 14 may be shaped into a variety of shapes based on a preference of the clinician 12, for example. The example illustrated in FIGS. 2-3 shows the recording device 14 as including a square shape. However, the recording device 14 may be patterned to include a rectangular shape, a circular shape, a triangular shape, a hexagonal shape, or the like (see FIG. 5). The recording device 14 may also be patterned or shaped to conform to the regular or irregular shape of a particular part of the body or clothing of a clinician 12, such as being shaped as a trapezoid to fit on the back of a clinician's hand. Additionally, the recording device 14 may also be configured to include a variety of colors. Furthermore, specialized logos, printed matter, advertisements, or a combination thereof may be disposed on the recording device 14. For example, the recording device 14 may include pre-printed matter to advertise a particular pharmaceutical, or to facilitate the recording of patient information such as the word “Temperature” followed by a space for recording the patient's temperature (e.g., “Temperature: ______”). In other words, the recording device 14 may be personalized based on the preferences of the clinician 12.

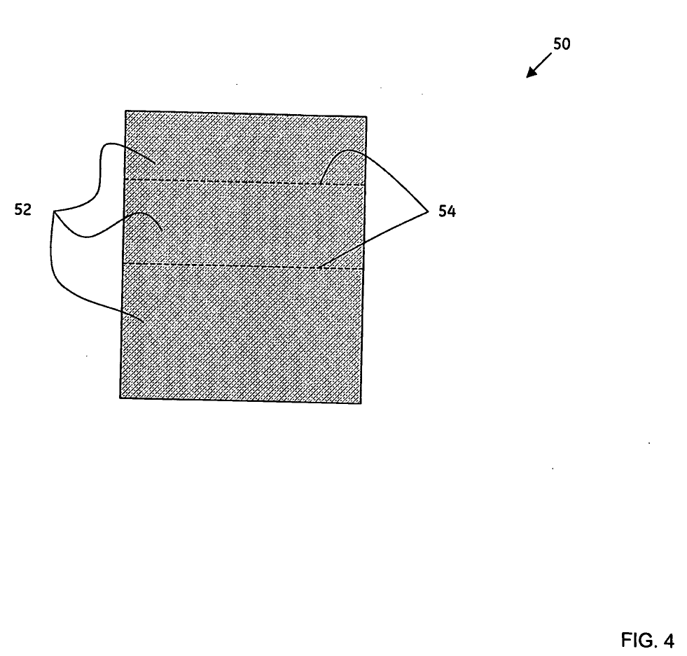

Moreover, in certain other embodiments, the recording device 14 may be configured to include one or more portions. Turning now to FIG. 4, a front view 50 of another embodiment of a recording device is illustrated. Reference numeral 52 may be representative of the one or more portions in the recording device 14. The one or more portions 52 may be configured to be detachably coupled to one another. In a presently contemplated configuration, the one or more portions may be detachably coupled to one another via use of perforations 54. Also, in certain embodiments, each of the one or more portions 52 may be configured to include portions of substantially the same size. Alternatively, the recording device 14 may be configured to include one or more portions having different sizes. By implementing the recording device 14 to include one or more portions 52, the clinician 12 may advantageously use only a desired portion of the recording device 14. Moreover, the clinician 12 may record information related to several patients on different portions 52 of the recording device 14, thereby enabling the different portions 52 to be directly transferred to respective patient files, such as the patient file 18 (see FIG. 1).

Referring again to FIG. 1, in accordance with further aspects of the present technique, the recording device 14 may include a disposable device. In other words, once the clinician has transferred the relevant information to the storage device, the recording device 14 may be disposed off. Alternatively, in certain other embodiments, the recording device 14 may be configured to include a reusable device. In other words, once the information recorded on the recording device 14 has been transcribed to the storage device, the recorded information on the front surface of the recording device 14 may be erased. The recording device 14 may then be re-affixed to the clinician 12 for multiple re-use.

As described hereinabove, the recording device 14 may be used in the healthcare arena. In accordance with further aspects of the present technique, the exemplary recording device 14 may also find application in inventory control. By way of example, during a inventory check, a user may note down inventory information on the recording device 14 to be subsequently transferred to a storage device. The recording device 14 may also find application in the monitoring and/or maintenance of equipment, such as aircraft engines, gas turbines, or the like.

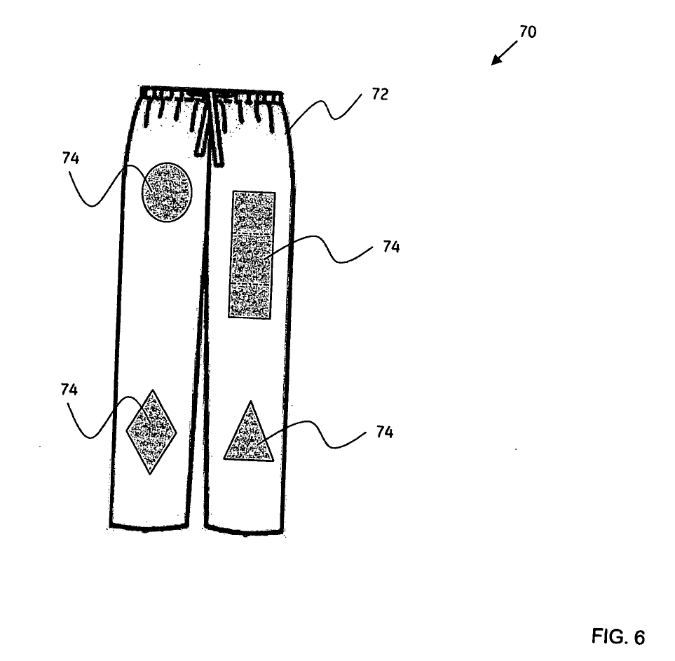

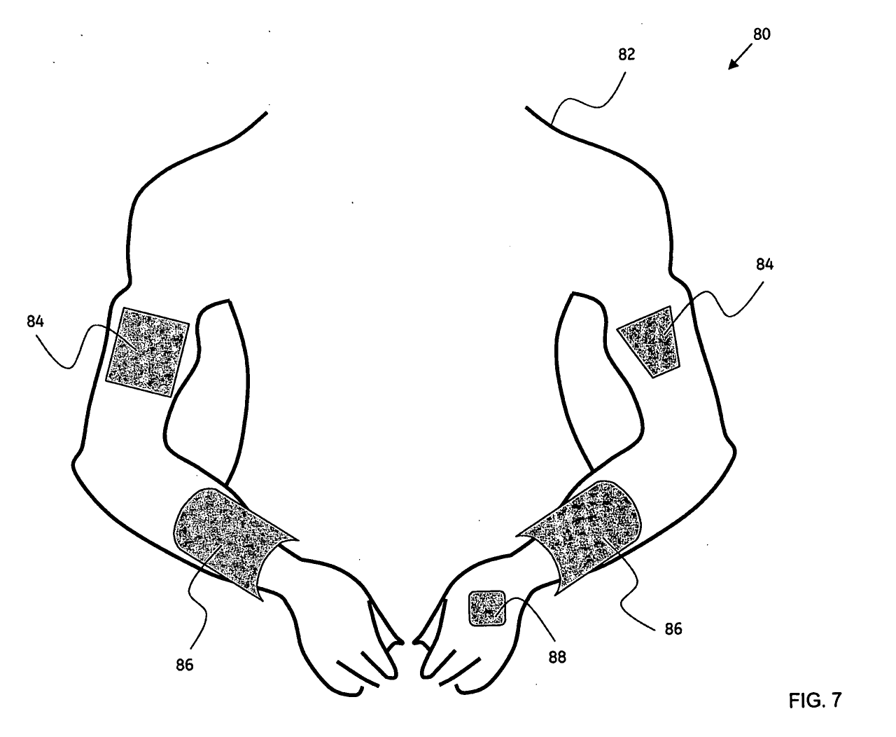

As described hereinabove, the recording device 14 may be removably and/or re-adherably affixed to the clinician 12. More particularly, the recording device 14 may be disposed on the clothing of the clinician, the body of the clinician, or a combination thereof. FIG. 5 depicts a diagrammatic illustration 60 of a plurality of recording devices 64 disposed on an upper-body garment 62 of the clinician 12 (see FIG. 1) In the example illustrated in FIG. 5, the upper-body garment is shown as including a shirt. Furthermore, in a similar fashion, FIG. 6 depicts a diagrammatic illustration 70 of a plurality of recording devices 14 disposed on a lower-body garment 72 of the clinician 12 (see FIG. 1). In the example illustrated in FIG. 6, the lower-body garment is shown as including pants. Turning now to FIG. 7, a diagrammatic illustration 80 of a plurality of recording devices, such as recording devices 14 of FIG. 1, disposed on a body 82 of the clinician 12, is depicted. Reference numeral 84 may be representative of recording devices disposed on the upper arms of the clinician 12, while recording devices disposed on the lower arms of clinician 12 may generally be represented by reference numeral 86. In addition, reference numeral 88 may generally representative of a recording device disposed on a hand of the clinician 12.

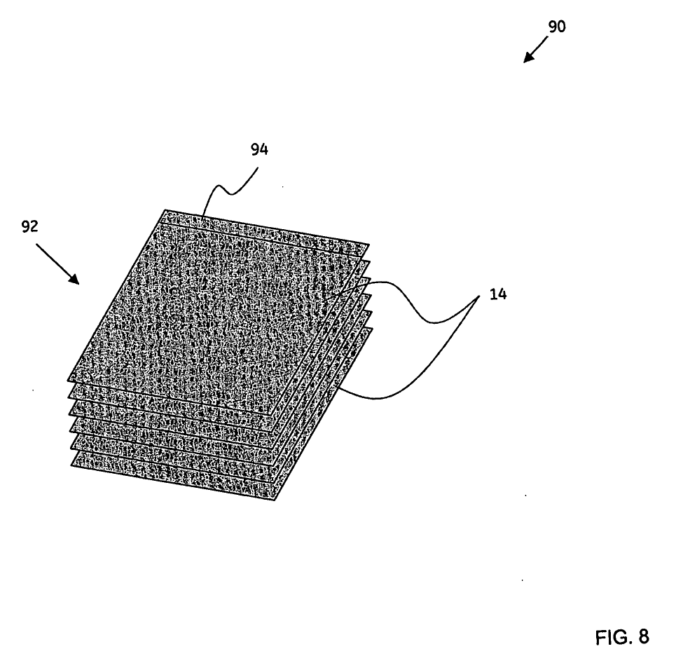

In accordance with further aspects of the present technique, a pad of recording devices is presented. Turning now to FIG. 8, a perspective view 90 of a pad 92 of recording devices, such as the recording device 14 (see FIG. 1), is illustrated. In other words, a plurality of recording devices 14 may be stacked in a predetermined direction to form a pad 92 of recording devices. In one embodiment, the plurality of recording devices 14 may be removably adhered to at least one other recording device via use of a strip of adhesive 94 disposed along an edge of each recording device. As previously noted, each recording device 14 may include a corresponding first surface and a second surface, where the first surface or front surface may be configured to allow a user to record information, while the second surface may have an adhesive disposed entirely or in part thereon and configured to allow the recording device 14 to be removably and/or reusably affixed to the user.

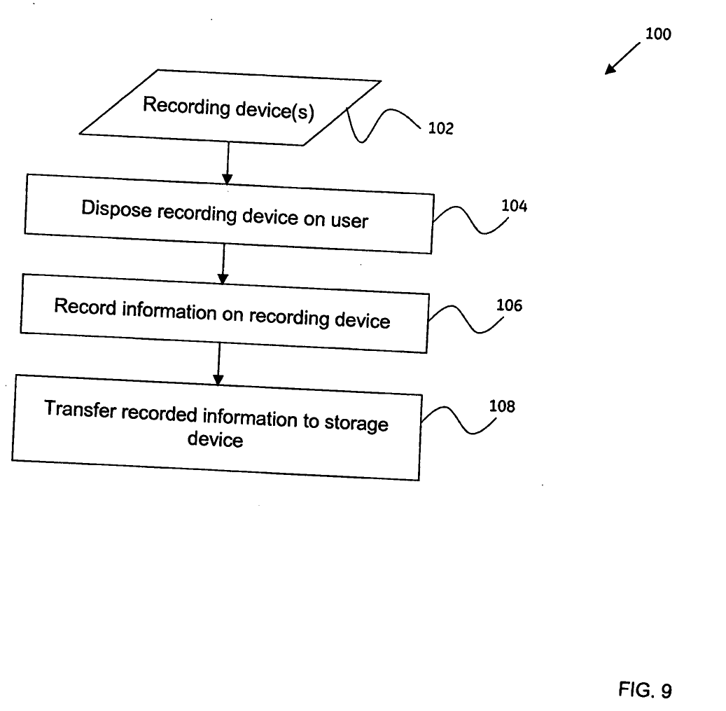

Further, in accordance with aspects of the present technique, a method for recording information using the exemplary recording device 14 (see FIG. 1) is presented. Referring now to FIG. 9, a flow chart 100 illustrating a method of recording information using the recording device 14 is depicted. The method starts at step 104, where one or more recording devices 102 may be disposed on a user, such as the clinician 12 (see FIG. 1). The recording devices 102 may include the recording device 14 (see FIG. 1), the recording device 50 (see FIG. 4), or a combination thereof. As previously noted, the one or more recording devices 102 may be disposed on the clothing of the clinician 12, the body of the clinician 12, or a combination thereof. Subsequently, at step 106, the clinician 12 may record information, such as patient data, on the recording devices 102. The clinician may then transfer the recorded information to a storage device, as indicated by step 108. The storage device may include the clinical flow sheet template 16 (see FIG. 1), the patient file 18 (see FIG. 1), the CIS 20 (see FIG. 1), or the like, as previously noted. In certain embodiments, the clinician 12 may peel off the recording device 102 from his/her clothing and/or body and duplicate the information onto the storage device. Alternatively, the clinician 12 may dispose the peeled off recording device 102 onto the clinical flow sheet template 16 and/or patient file 18. Furthermore, the recording device 102 may be scanned and the recorded information may be uploaded to the CIS 20, for instance.

The system for recording information and the method for recording information described hereinabove dramatically simplify clinical workflow by advantageously allowing the user to note down information even when the user is in a location removed from the storage device, for instance. Additionally, the recording device may be configured for use as a “second skin” that may be removably and/or re-usably adhered to the clothing and/or the body of the user of the recording device, where the “second skin” may be configured to aid the user in recording information and also saves the user precious time that may otherwise be spent scrubbing ink off hands, arms or clothes. The user of the recording device or “second skin” may use a pen or marker that is waterproof thus preventing smears and/or accidental erasure of vital information. The “second skin” may also be easily removed without destroying the recorded information, thereby enabling transfer of information to the storage device. In other words, the “second skin” may be peeled off and discarded with very little effort. Moreover, the recording device 14 may be re-used multiple times.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A recording device, comprising:
a material having a front surface and a back surface, wherein the front surface is configured to allow a user to record information, wherein the back surface has an adhesive disposed thereon, and wherein the recording device is configured to be removably and re-adherably affixed to the user.

2. The recording device of claim 1, wherein the material comprises a paper, a cloth, a ribbon, a flexible plastic, or other tear resistant materials.

3. The recording device of claim 1, wherein the material is patterned in a variety of shapes.

4. The recording device of claim 3, wherein the material comprises a variety of colors.

5. The recording device of claim 2, wherein the material is configured for use in healthcare, inventory control, equipment maintenance, or monitoring of machinery.

6. The recording device of claim 1, wherein the adhesive comprises a colorless, clear, non-marking, removable and re-stickable adhesive.

7. The recording device of claim 1, wherein the recording device comprises a disposable device.

8. The recording device of claim 1, wherein the recording device comprises a reusable device.

9. The recording device of claim 1, wherein the recording device comprises a waterproof material.

10. The recording device of claim 1, wherein the recording device comprises one or more portions.

11. The recording device of claim 10, wherein the one or more portions are detachably coupled to one another.

12. The recording device of claim 1, wherein the information is recorded on the front surface of the recording device via use of a marking device.

13. The recording device of claim 12, wherein the marking device comprises an erasable marking device.

14. The recording device of claim 1, wherein the recording device comprises a placeholder for printed material, and wherein the placeholder may be disposed on a portion of the front surface of the recording device.

15. A pad of recording devices, comprising:
a stack of a plurality of recording devices, wherein each of the plurality of recording devices is removably adhered to at least one recording device, wherein each of the plurality of recording devices comprises a material having a front surface and a back surface, wherein the front surface is configured to allow a user to record information, wherein the back surface has an adhesive disposed thereon, and wherein the recording device is configured to be removably and re-adherably affixed to the user.

16. The pad of claim 15, wherein each of the plurality of recording devices is removably adhered to at least one other recording device via use of a strip of adhesive disposed along an edge of each recording device.

17. A method for recording information via use of a recording device, wherein the recording device comprises:
a material having a front surface and a back surface, wherein the front surface is configured to allow a user to record information, wherein the back surface has an adhesive disposed on the back surface, and wherein the recording device is configured to be removably and re-adherably affixed to the user,
the method comprising:
disposing the recording device on the user;
recording information on the recording device; and
transferring the recorded information to a storage device.

18. The method of claim 17, wherein disposing the recording device on the user comprises disposing the recording device on a body of the user, on clothing of the user, or a combination thereof.

19. The method of claim 17, wherein recording information on the recording device comprises recording information on the recording device via use of a marking device.

20. The method of claim 17, wherein the storage device comprises a clinical flow sheet template, a patient file, a clinical information system, or combinations thereof.

21. The method of claim 17, wherein transferring the recorded information to the storage device comprises:
removably detaching the recording device from the user; and
duplicating the information from the recording device to the storage device.

22. The method of claim 21, further comprising disposing the recording device in the storage device.

23. The method of claim 21, further comprising cleaning the recording device by erasing information recorded on the front surface of the recording device.

24. The method of claim 23, further comprising re-affixing the cleaned recording device on the user.
